(19) United States
(12) Patent Application Publication
(10) Pub. No.: US 2026/0261476 A1
(43) Pub. Date: Sep. 3, 2026

(54) WIRELESSLY CONTROLLING SERVER-HOSTED APPLICATIONS WITH MOBILE DEVICES

(71) Applicant: Adobe Inc., San Jose, CA (US)

(72) Inventors: Sourav Suman, Kendrapara (IN); Deepanshu Sharma, Bhilwara (IN); Ayan Banerjee, Bengaluru (IN)

(21) Appl. No.: 19/066,568

(22) Filed: Feb. 28, 2025

(51) Int. Cl. H04L 41/0806; H04L 41/0895

(52) U.S. Cl. CPC H04L 41/0809; H04L 41/0895

(57) ABSTRACT

The present disclosure relates to systems, non-transitory computer readable media, and methods for providing a virtual controller for interacting with a server-hosted digital media application. In one or more embodiments, the disclosed systems determine, by a secondary client device via a local network, connection information for an open connection channel established with an application server hosting a digital media editing application via a primary client device running an active session of the digital media editing application. In some embodiments, the disclosed systems provide a control user interface on the secondary client device for interacting with the active session running on the primary client device. In some embodiments, in response to receiving a user interaction via the control user interface, the disclosed systems send an instruction from the secondary client device to the application server to control the active session of the digital media editing application via the open connection channel.

### BACKGROUND

Recent years have seen significant advancements in hardware and software platforms for creating and editing digital media. For example, many platforms offer server-hosted software applications that provide powerful and intuitive tools for content creation. With the increasing demand for precision and efficiency in digital media editing, many users acquire various peripheral devices, such as high-resolution displays, to access and edit digital content with added focus and less distractions. Despite advancements in digital media editing tools and multi-client connectivity solutions, however, conventional platforms suffer from a variety of issues in relation to accessibility, efficiency, and operational flexibility of creating and editing digital content.

### BRIEF SUMMARY

Embodiments of the present disclosure provide benefits and/or solve one or more problems in the art with systems, non-transitory computer readable media, and methods for providing a virtual controller for interacting with server-hosted digital media applications. To illustrate, in some embodiments, the disclosed systems provide an open connection between a secondary client device (e.g., a mobile device) and a server-hosted desktop application via an open connection channel established with an application server hosting the application by a primary device running the application (e.g., a laptop or desktop computer). In some implementations, the secondary client device obtains the requisite connection information using a zero-configuration networking protocol to connect the secondary client device with the application server with little to no user interaction required. Additionally, in one or more implementations, the disclosed systems provide a customizable control user interface on the secondary client device for interacting with an active session of the application running on the primary client device, allowing users to control editing features through the customizable control user interface.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a virtual controller integration system operates in accordance with one or more embodiments.

FIG. 2 illustrates an overview of the virtual controller integration system establishing an open connection channel with an application server for interacting with an active session of a digital media editing application running on a primary client device in accordance with one or more embodiments.

FIG. 3 illustrates the virtual controller integration system establishing an open connection channel for receiving instructions from a plurality of secondary client devices for interacting with digital media accessed by a primary client device in accordance with one or more embodiments.

FIG. 4 illustrates the virtual controller integration system providing a control user interface on a secondary client device for interacting with digital media accessed by a primary client device and displayed on a peripheral device in accordance with one or more embodiments.

FIG. 5 illustrates the virtual controller integration system providing a customizable virtual controller for interacting with an active session of a digital media editing applications in accordance with one or more embodiments.

FIG. 6 illustrates a diagram of an example architecture of the virtual controller integration system in accordance with one or more embodiments.

FIGS. 7-8 illustrate respective flowcharts of two series of acts for providing a control user interface on a secondary client device and sending instructions to an application server via an open connection channel with an application server in accordance with one or more embodiments.

FIG. 9 illustrates a block diagram of an example computing device for implementing one or more embodiments of the present disclosure.

### DETAILED DESCRIPTION

This disclosure describes one or more embodiments of a virtual controller integration system that provides a virtual controller for interacting with server-hosted digital media applications. For example, in some embodiments, the virtual controller integration system implements a customizable virtual controller application on a secondary client device (e.g., a mobile device) for controlling an active session of a digital media editing application running on a primary client device (e.g., a laptop or desktop computer) and hosted by an application server. In particular, in certain embodiments, the virtual controller integration system utilizes an open connection channel, a zero-configuration networking protocol, and customizable control user interface to provide a wireless remote control solution for improved user comfort, convenience, and operation flexibility when utilizing server-hosted (e.g., cloud-based) applications for content creation and editing.

To illustrate, in one or more embodiments, the virtual controller integration system determines, by a secondary client device via a local network, connection information for an open connection channel established with an application server hosting a digital media editing application via a primary client device running an active session of the digital media editing application. In some embodiments, the virtual controller integration system provides a control user interface on the secondary client device for interacting with the active session of the digital media editing application hosted by the application server and running on the primary client device. For example, in response to detecting a user interaction with the control user interface on the secondary client device, the virtual controller integration system sends an instruction from the secondary client device to the application server to control the active session of the digital media editing application via the open connection channel established with the application server via the primary client device. Furthermore, in some embodiments, the virtual controller integration system sends an instruction via the open connection channel to cause the application server to modify, according to the user interaction with the control user interface, digital content accessed within the active session on the primary client device and displayed on a peripheral device.

As mentioned, in some embodiments, the virtual controller integration system provides a control user interface with a variety of controls that are customizable according to user preference and specific application modes. In some implementations, for example, the virtual controller integration system provides a plurality of operable controls linked to a respective plurality of actionable features of a digital media editing applications and, in some cases, allows a user to select which specific controls are displayed via a control user interface of a secondary client device. Moreover, in some embodiments, the virtual controller integration system allows the user to select both an actionable feature to control and a type of control to implement, such as a style of virtual control on a touchscreen display or assignment of a control to a particular physical interface (e.g., a knob or button of a web-enabled physical controller).

As mentioned above, conventional systems suffer from a number of issues relating to computational and operational inefficiencies and inflexibilities. For example, many conventional systems require the use of a custom-built controller, such as a Musical Instrument Digital Interface (MIDI) controllers, to provide peripheral controls for digital media editing applications. Many such controllers require a wired connection to the primary client device running the digital media editing application and are often quite expensive due to the need for a custom design. Some alternative conventional solutions provide a virtual controller via a mobile application in communication with the primary client device running the digital media editing application via wireless connections such as Bluetooth or WIFI, but such connections often result in poor latency as the primary client device must relay information back to the application server for processing before implementing any instructions received from the mobile device.

In one or more embodiments, the virtual controller integration system improves computational and operational efficiency by providing a virtual controller in direct communication with an application server via an open connection channel between a secondary client device (e.g., a mobile device or other web-enable device) and an application server for interacting with an active session of a server-hosted application on a primary client device (e.g., a laptop or desktop computer). By sending and receiving information directly from the application server, the virtual controllers provided by the virtual controller integration system operated with significantly reduced latency compared to conventional systems. Furthermore, in one or more embodiments, the virtual controller integration system utilizes zero-configuration networking to instantly connect one or more secondary client devices to an established open connection channel without user input for network configuration, further increasing the efficiency of providing a virtual controller for interacting with the application hosted by the application server and running on the primary client device.

Moreover, in one or more embodiments, the virtual controller integration system improves the operational flexibility for providing useful controls for interacting with digital media opened within an active session of a server-hosted application running on a primary client device. For instance, embodiments of the virtual controller integration system enable the use of virtually any secondary client device with a connection to the internet to be used as a wireless virtual controller with low-latency and minimal user setup to control and interact with digital media via a server-hosted application running on a primary client device. Furthermore, in one or more embodiments, the virtual controller integration system provides a control user interface that is customizable according to the actionable features of a particular application and user preferences for specific types of digital media editing tools and controls (e.g., controls targeting limited set of application features according to user preference), thus increasing both the flexibility and efficiency of creating and editing digital media using server-hosted digital media editing applications.

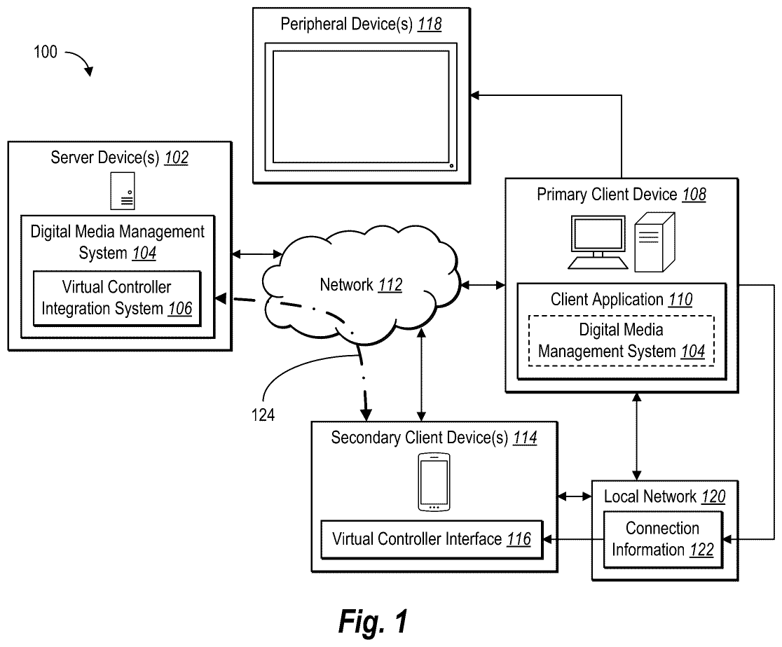

Additional detail will now be provided in relation to illustrative figures portraying example embodiments and implementations of a virtual controller integration system. For example, FIG. 1 illustrates a system environment 100 in which a virtual controller integration system 106 operates in accordance with one or more embodiments. As illustrated, the system environment 100 includes server device(s) 102 (e.g., one or more application servers), a primary client device 108, secondary client device(s) 114, peripheral device(s) 118, and a network 112. As further illustrated, the server device(s) 102, the primary client device 108, and the secondary client device(s) 114 are able to communicate with one another via the network 112. Moreover, although FIG. 1 shows the peripheral device(s) 118 in direct communication with the primary client device 108, in some embodiments, the primary client device 108 and the peripheral device(s) 118 are connected via the network 112 or a local network 120 (e.g., utilizing a network-enabled display or other peripheral device).

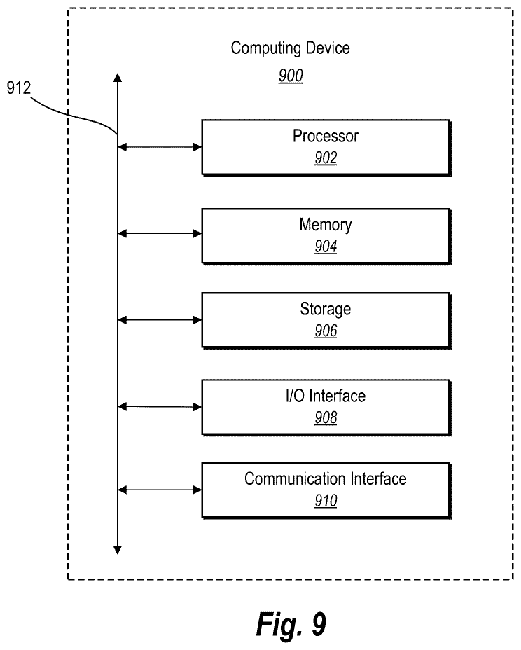

As shown in FIG. 1, the server device(s) 102 includes a digital media management system 104 that further includes the virtual controller integration system 106. According to one or more embodiments, the digital media management system 104 manages digital media accessed (e.g., viewed, generated, and/or modified) via one or more client applications hosted by the server device(s) 102 (e.g., for generating, editing, and/or analyzing digital media via various tools). Additionally, in some embodiments, the server device(s) 102 host one or more digital media editing applications (e.g., within the digital media management system 104). For example, in some implementations, the primary client device 108 accesses the digital media management system 104 (and one or more digital media editing applications thereof) via a client application 110. In some embodiments, the server device(s) 102 includes, but is not limited to, a computing device (such as explained below with reference to FIG. 9).

In one or more embodiments, a digital media editing application includes a computer program comprising tools for creating and editing digital content, such as but not limited to digital images, photographs, videos, graphical designs, graphical user interfaces, musical compositions, and so forth. In some cases, for example, a digital media editing application includes a cloud-based desktop application or web browser-based application for editing digital content using various tools, including cloud-based subroutines for modifying digital content. Moreover, in some cases, a digital media editing application includes one or more generative artificial intelligence-based tools for creating and/or editing digital content.

Furthermore, as shown in FIG. 1, the system environment 100 includes the primary client device 108. In some embodiments, the primary client device 108 includes, but is not limited to, a laptop computer, a desktop computer, or any other type of computing device, including those explained below with reference to FIG. 9. Some embodiments of primary client device 108 perform a variety of functions via the client application 110. For example, the primary client device 108 (through the client application 110) performs functions such as, but not limited to, accessing digital content via an active session of a digital media editing application hosted by the server device(s) 102 and running on the primary client device 108, establishing an open connection channel 124 with the server device(s) 102 for interacting with the active session running on the primary client device 108, advertising connection information 122 for the open connection channel 124 on the local network 120, and displaying digital content accessed within the active session on the peripheral device(s) 118. In one or more embodiments, a local network includes a network, such as Local Area Network (LAN) or other local connection service (e.g., Bluetooth or WIFI) that connects computers and devices within a limited geographic area, such as a single building or campus.

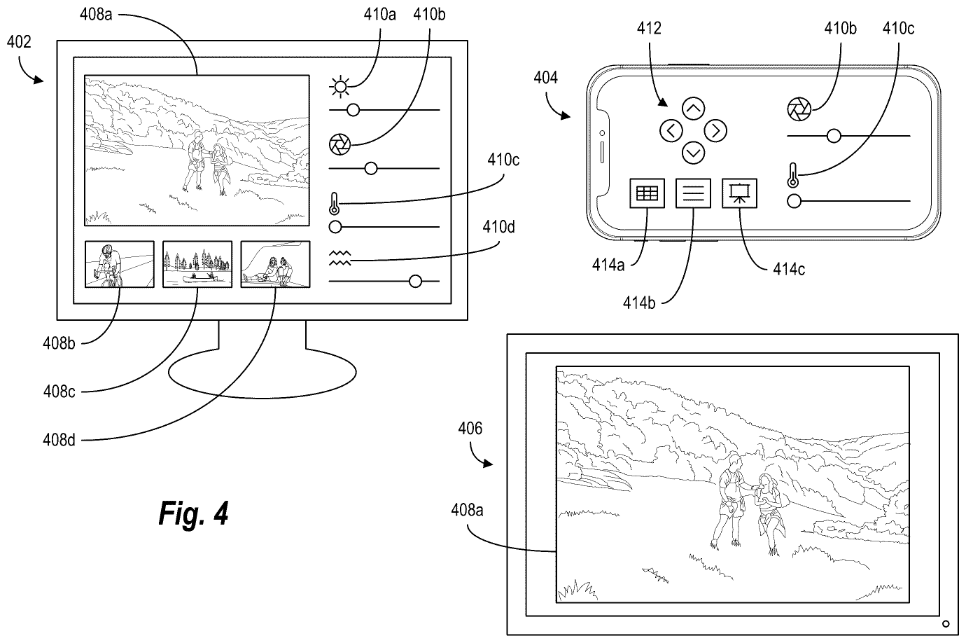

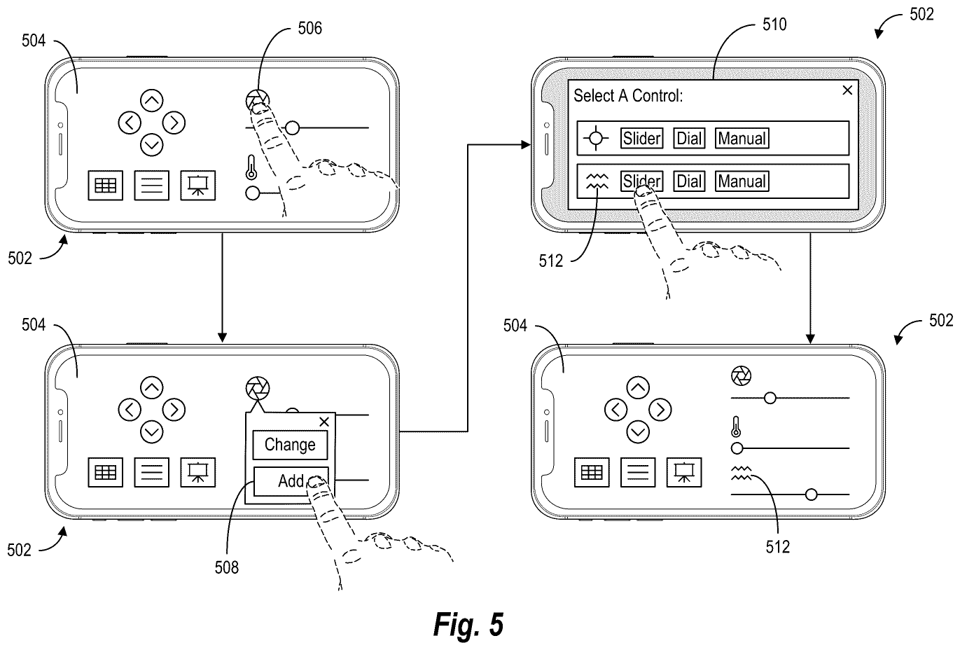

As also shown in FIG. 1, the system environment includes one or more secondary client device(s) 114. In some embodiments, the secondary client device(s) 114 include, but are not limited to, mobile devices, tablet computers, web- or network-enabled controller devices or control surfaces, or any other type of computing device, including those explained below with reference to FIG. 9. To access the open connection channel 124 established with the server device(s) 102 via the primary client device 108, in one or more embodiments, the secondary client device(s) 114 obtain the connection information 122 advertised on the local network 120. For example, the secondary client device(s) 114 perform function such as, but not limited to, providing a virtual controller interface 116 (e.g., a control user interface as described below in relation to FIGS. 4-5) for interacting with an active session of a digital media editing application running on the primary client device 108 and hosted by the server device(s) 102, receiving user interactions with the virtual controller interface 116 (e.g., to select and/or interact with digital content within the active session), and sending instructions to the server device(s) 102 via the open connection channel 124 to interact with digital content and/or control one or more features of the active session of the digital media editing application running on the primary client device 108 (and, in some cases, displayed on the peripheral device(s) 118).

Further, although FIG. 1 illustrates the virtual controller integration system 106 being implemented by a particular component and/or device within the system environment 100 (e.g., the server device(s) 102, the primary client device 108, and/or the secondary client device(s) 114), in some embodiments the virtual controller integration system 106 is implemented, in whole or in part, by other computing devices and/or components in the system environment 100. For instance, in some embodiments, the virtual controller integration system 106 is implemented on another client device. More specifically, in one or more embodiments, the description of (and acts performed by) the virtual controller integration system 106 are implemented by (or performed by) the client application 110 on another client device.

In some embodiments, the client application 110 includes a web hosting application that allows the primary client device 108 to interact with content and services hosted on the server device(s) 102. To illustrate, in one or more implementations, the primary client device 108 accesses a web page or computing application supported by the server device(s) 102. The primary client device 108 provides input to the server device(s) 102 (e.g., a request to establish the open connection channel 124 with the server device(s) 102). In response, the virtual controller integration system 106 on the server device(s) 102 performs operations described herein to establish the open connection channel 124 and thereby receive instructions from the secondary client device(s) 114 for interacting with an active session of a digital media editing application hosted by the digital media management system 104 on the server device(s) 102. The server device(s) 102 provide the output or results of the operations (e.g., an image modification, an updated selection, a change to a viewing mode or setting, etc.) to the primary client device 108.

Additionally, as shown in FIG. 1, the system environment 100 includes the network 112. As mentioned above, in some instances, the network 112 enables communication between components of the system environment 100. In certain embodiments, the network 112 includes a suitable network and communicates using any communication platforms and technologies suitable for transporting data and/or communication signals, examples of which are described with reference to FIG. 9. Furthermore, although FIG. 1 illustrates the server device(s) 102, the primary client device 108, and the secondary client device(s) 114 communicating via the network 112, in certain embodiments, the various components of the system environment 100 communicate and/or interact via other methods (e.g., the server device(s) 102 and the primary client device 108 communicate directly).

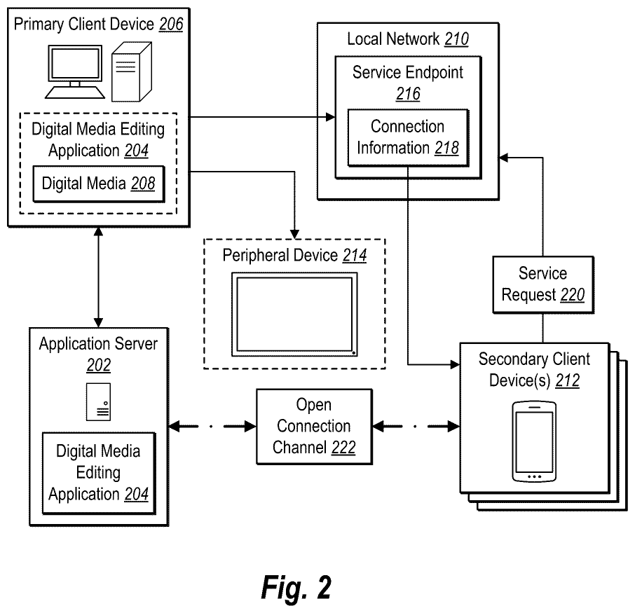

As mentioned above, in some embodiments, the virtual controller integration system 106 provides a virtual controller for interacting with an active session of a digital media editing application running on a primary client device via an open connection channel established with an application server hosting the digital media editing application. For example, FIG. 2 illustrates the virtual controller integration system 106 performing operations including (i) establishing an open connection channel 222 with an application server 202 hosting a digital media editing application 204 via a primary client device 206 running an active session of the digital media editing application 204 and (ii) receiving connection information 218 for the open connection channel 222 at one or more secondary client device(s) 212 in accordance with one or more embodiments.

As shown in FIG. 2, the application server 202 hosts the digital media editing application 204 in communication with the primary client device 206. In some embodiments, for example, the primary client device 206 accesses the digital media editing application 204 via desktop application or through an internet browser. As such, in some embodiments, the application server 202 performs at least some of the features of the digital media editing application 204 in accordance with instructions received via an active session of the digital media editing application 204 on the primary client device 206. As illustrated, for example, the primary client device initiates an active session of the digital media editing application 204 and accesses (e.g., opens) digital media 208.

In some embodiments, digital media refers to digital content including, but not limited to, digital images, photographs, videos, graphical designs, graphical user interfaces, musical compositions, digital documents, presentations, and so forth. Indeed, digital media can include any type of digital content accessible via a digital media editing application. In some implementations, for example, the digital media editing application 204 accesses and displays (e.g., via a display of the primary client device 206 or via a peripheral device 214) a selection of digital images, such as photographs uploaded by a user, and provides tools for annotating, editing, and/or collaborating on the selection of digital images. Accordingly, while much of the foregoing disclosure and accompanying figures are directed to an implementation for editing and/or interacting with digital images, embodiments of the virtual controller integration system are not limited to any specific type or category of digital media.

As further illustrated in FIG. 2, the virtual controller integration system 106 establishes the open connection channel 222 with the application server 202 (e.g., one or more server devices) hosting the digital media editing application 204. In some embodiments, the open connection channel 222 includes a continuous full-duplex communication channel by which a connected client device is able to send instruction to, and receive information from, the application server 202. In one or more embodiments, for example, the open connection channel 222 comprises a simultaneous two-way communication channel over a single (TCP) connection, such as but not limited to a connection channel implemented according to the WebSocket protocol. Accordingly, in one or more embodiments, the primary client device 206 sends a request (e.g., a Hypertext Transfer Protocol (HTTP) request) to the application server 202 to establish the open connection channel 222 for communication with client devices associated with the primary client device 206.

As illustrated, the primary client device 206 advertises (e.g., posts or broadcasts) a service endpoint 216 with the connection information 218 for the established open connection channel 222 on a local network 210. In some embodiments, for example, the primary client device 206 advertises the connection information 218 on the local network 210 utilizing Zero-configuration (Zeroconf) networking protocols or standards. Accordingly, in some embodiments, the secondary client device(s) 212 determine the connection information 218 as advertised on the local network 210 to access the open connection channel 222 with the application server 202. To illustrate, in one or more embodiments, the secondary client device(s) 212 transmit a service request 220 via the local network 210 and accordingly discover the service endpoint 216 with the connection information 218. Alternatively, in some embodiments, the service endpoint 216 comprises a discoverable remote service and the secondary client device(s) 212 automatically identify the connection information 218 via the local network 210 without issuance of a service request.

As shown in FIG. 2, the secondary client device(s) 212 identify the service endpoint 216 advertised on the local network 210 and receives the connection information 218 for the open connection channel 222. Upon receiving the connection information 218, the secondary client device(s) 212 communicate directly with the application server 202 via the open connection channel 222 to interact with the active session of the digital media editing application 204 running on the primary client device 206 (e.g., as described below in relation to FIG. 4). In particular, in one or more embodiments, the secondary client device(s) 212 send instructions directly to the application server 202 via the open connection channel 222, thus bypassing the primary client device 206 when interacting with server-hosted features of the digital media editing application 204. In response to receiving instructions from the secondary client device(s) 212 via the open connection channel 222, the application server 202 implements the instructions—whether they be for navigation, editing, or other operation of the digital media editing application 204—and transmits the resultant action or change to the primary client device 206. In some cases, the resultant action or change is also displayed by the primary client device 206 via the peripheral device 214 (e.g., changing a view, modifying an image, etc.).

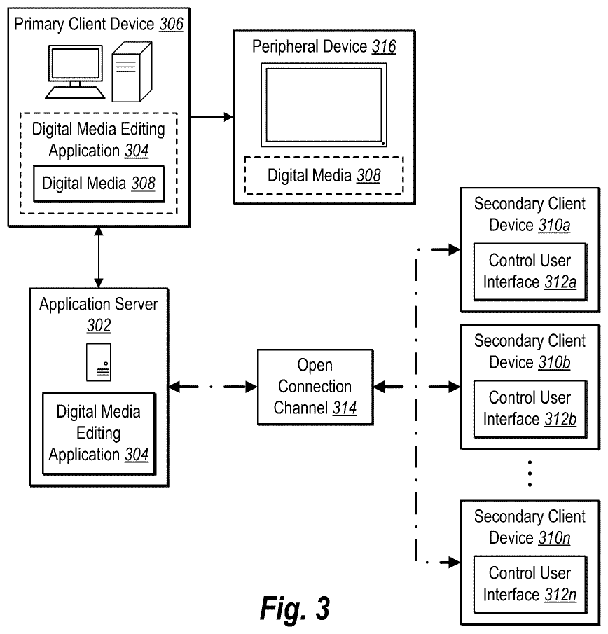

As mentioned previously, in some embodiments, the virtual controller integration system 106 provides multiple virtual controllers via multiple secondary client devices for interacting with an active session of a server-hosted application running on a primary client device. To illustrate, FIG. 3 shows the virtual controller integration system 106 establishing an open connection channel 314 with an application server 302 for interacting with an active session of a digital media editing application 304 on a primary client device 306 via multiple secondary client devices 310a-310n.

As shown in FIG. 3, the application server 302 hosts the digital media editing application 304 in communication with the primary client device 306, which accesses digital media 308 (e.g., digital content) within an active session of the digital media editing application 304. Also, the primary client device 306 displays the digital media 308 via a peripheral device 316, such as an external monitor, projector, or television connected to the primary client device 306. In some implementations, for example, the primary client device 306 utilizes the peripheral device 316 to display the digital media 308 in a larger format and/or with fewer secondary elements (e.g., menus, control interfaces, or other application windows) relative to a primary display of the primary client device 306. In such implementations, the peripheral device 316 and the one or more virtual controllers provided by the virtual controller integration system 106 enhance the capabilities of the digital media editing application 304 for collaborative interaction with the digital media 308 displayed on the peripheral device 316 and/or for individual interactions via a plurality of virtual controllers.

As illustrated, the secondary client devices 310a-310n access the open connection channel 314 (e.g., as discussed above in relation to FIG. 2) established with the application server 302 to communicate directly with the application server 302 when interacting with the active session of the digital media editing application 304 running on the primary client device 306. In addition, the virtual controller integration system 106 provides, via the secondary client devices 310a-310n, respective control user interfaces 312a-312n for interacting with the active session of the digital media editing application 304 running on the primary client device 306, including interactions with the digital media 308 displayed on the peripheral device 316. Furthermore, in some embodiments, each of the control user interfaces 312a-312n comprise individually customizable controls for selectively interacting with and controlling operable features of the digital media editing application 304.

By providing the open connection channel 314 to enable direct communications between the application server 302 and the multiple secondary client devices 310a-310n, the virtual controller integration system 106 enables both collaborative interaction (e.g., simultaneous control given to multiple users) with the digital media 308 and interactions by a single user via multiple virtual controllers. In some implementations, for example, the respective control user interfaces 312a-312n of the secondary client devices 310a-310n comprise individual controls that differ according to user preference and/or the corresponding device (e.g., differences in screen size or other available interface elements).

As mentioned previously, in some embodiments, the virtual controller integration system 106 provides a virtual controller via a secondary client device for interacting with digital content accessed by a primary client device and displayed on a peripheral device. For example, FIG. 4 illustrates the virtual controller integration system 106 providing a control user interface on a secondary client device 404 for interacting with digital media accessed by a primary client device 402 and displayed on a peripheral device 406.

As shown in FIG. 4, the primary client device 402 accesses digital media, including digital images 408a-408d, within an active session of a digital media editing application. As shown, a user interface of the primary client device 402 displays the digital images 408a-408d. In particular, the digital image 408a is emphasized (e.g., enlarged compared to the other digital images) as a currently selected image for editing. As such, the user interface of the primary client device 402 also includes multiple operable controls 410a-410d for implementing modifications or adjustments to the digital image 408a. Specifically, the operable control 410a is configured to adjust the brightness of the digital image 408a, the operable control 410b is configured to adjust the exposure, the operable control 410c is configured to adjust the temperature, and the operable control 410d is configured to adjust the sharpness. In various implementations, the user interface of the primary client device 402 includes fewer or additional operable controls than shown in FIG. 4, such as a variety of adjustable sliders or dials, selectable options, or menus related to various actionable features of the digital media editing application running on the primary client device 402.

As also shown in FIG. 4, the peripheral device 406 comprises an external monitor, television, or other peripheral display portraying the digital image 408a without controls, menu, or other features shown within the user interface of the primary client device 402. Accordingly, the peripheral device 406 displays the digital image 408a alone for ease of viewing and minimal distractions from the digital image 408a when viewing on the peripheral device 406.

As further shown in FIG. 4, the secondary client device 404 includes a control user interface without display of digital image 408a. Specifically, the control user interface of the secondary client device includes navigation controls 412 and a set of selectable options 414a-414c for interacting with the active session of the digital media editing application running on the primary client device 402. By interacting with the navigation controls 412, for example, a user is able to make selections that cause the secondary client device 404 to send instructions to scroll through images open within the active session of the digital media editing application on the primary client device 402, thus changing the display of the digital image 408a on the peripheral device to a different image and to initiate editing of the newly selected image. Alternatively, by interacting with the selectable option 414a, the user is able to make selections that cause the secondary client device 404 to send instructions to change the current view on the peripheral device 406 and/or the primary client device 402 from an individual emphasized image to a grid of digital images for viewing and/or selection. From within the selected grid view, the user is able to make selections that cause the secondary client device 404 to send instructions to navigate between digital images of the grid using the navigation controls 412 on the secondary client device. Also, by interacting with the selectable option 414b, the user is able to make selections that cause the secondary client device 404 to send instructions to access a menu with additional options and navigate through the additional options using the navigation controls 412. Finally, by interacting with the selectable option 414c, the user is able to make selections that cause the secondary client device 404 to send instructions that cause the primary client device 402 and/or the peripheral device 406 to enter a presentation mode of the digital media editing application.

As illustrated, the control user interface on the secondary client device 404 also includes the operable controls 410b and 410c for respectively adjusting the exposure and the temperature of the digital image 408a. By interacting with either of the operable controls 410b or 410c on the secondary client device, for example, a user is able to make selections that cause the secondary client device 404 to send instructions that cause the digital media editing application 204 to modify the digital image 408a displayed on the peripheral device 406 by the primary client device 402. In some embodiments, the virtual controller integration system 106 provides fewer or additional operable controls via a customizable control user interface on the secondary client device 404 (e.g., as described below in relation to FIG. 5).

As mentioned previously, in some embodiments, the virtual controller integration system 106 provides a customizable control user interface on a secondary client device for interacting with an active session of a digital media editing application running on a primary client device. For example, FIG. 5 illustrates the virtual controller integration system 106 providing a control user interface 504 with customizable controls on a secondary client device 502.

As shown in FIG. 5, the control user interface 504 of the secondary client device 502 includes an initial configuration of navigation controls, selectable options, and operable controls for interacting with a particular digital media editing application. As illustrated, in response to a user interaction with a customizable control 506 within the control user interface 504, such as a long press on a touchscreen of the secondary client device 502, the virtual controller integration system 106 provides, on the secondary client device 502, a drop down menu with multiple selectable options (denoted “Change” and “Add”). In response to a subsequent user interaction with a selectable option 508 to add an operable control to the control user interface 504, the virtual controller integration system 106 provides, on the secondary client device 502, a menu 510 with selectable options for adding various controls associated with actionable features of the particular digital media editing application. Finally, in response to a user interaction with one of the selectable options provided for an operable control 512 for adjusting image sharpness, the virtual controller integration system 106 includes the operable control 512 within the control user interface 504 on the secondary client device 502.

As also mentioned, in some embodiments, the virtual controller integration system 106 provides a customizable control user interface comprising one or more physical controls of a digital controller device or control surface device, such as a web-enabled and programmable Musical Instrument Digital Interface (MIDI) controller or other related devices. In some embodiments, for example, the virtual controller integration system 106 associates the one or more physical controls of a device with one or more respective actionable features of a particular digital media editing application in accordance with user or manufacturer preferences.

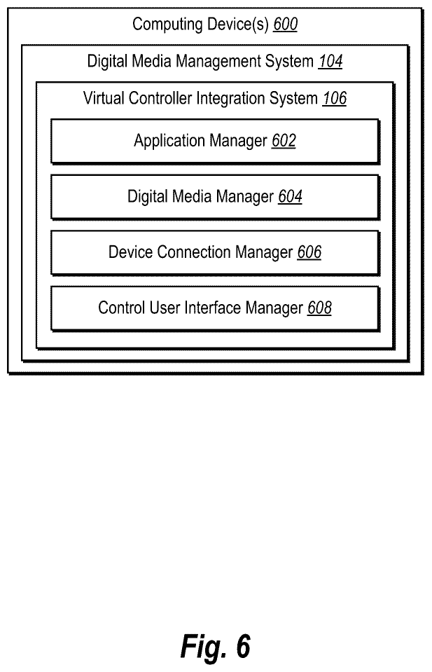

Turning now to FIG. 6, additional detail will be provided regarding components and capabilities of one or more embodiments of the virtual controller integration system 106. In particular, FIG. 6 illustrates an example virtual controller integration system 106 executed by a computing device(s) 600 (e.g., the server device(s) 102, the primary client device 108, and/or the secondary client device(s) 114). As shown by the embodiment of FIG. 6, the computing device(s) 600 includes or hosts the digital media management system 104 and/or the virtual controller integration system 106. Furthermore, as shown in FIG. 6, the virtual controller integration system 106 includes an application manager 602, a digital media manager 604, a device connection manager 606, and a control user interface manager 608.

As shown in FIG. 6, the virtual controller integration system 106 includes the application manager 602. In some implementations, the application manager 602 stores, accesses, provides, and/or manages one or more digital media editing applications hosted by an application server, such as but not limited to one or more cloud-based digital media applications. In some implementations, the application manager 602 facilitates communications between a primary client device and an application server in support of an active session of a digital media editing application running on the primary client device and hosted by the application server. For example, in some implementations, the application manager 602 transmits and/or receives instructions from the primary client device to the application server to modify digital content within the active session, generates the modification(s) as instructed, and relays the results to the primary client device.

In addition, as shown in FIG. 6, the virtual controller integration system 106 includes the digital media manager 604. In some implementations, the digital media manager 604 generates, modifies, stores, and/or accesses digital media (e.g., digital content). In some implementations, for instance, the digital media manager 604 accesses digital content and uploads the digital content to an application server for viewing and/or editing within an active session of a digital media editing application running on a primary client device in communication with the application server. Moreover, in some implementations, the digital media manager 604 relays modified digital content generated on the application server to the primary client device for display within the active session running on the primary client device.

Moreover, as shown in FIG. 6, the virtual controller integration system 106 includes the device connection manager 606. In some implementations, the device connection manager 606 requests, establishes, advertises, and/or implements an open connection channel with an application server hosting a digital media editing application via a primary client device running an active session of the digital media editing application. In response to initiation of an active session of the digital media editing application on the primary client device, for example, the device connection manager 606 establishes the open connection channel with the application server and advertises, on a local network via the primary client device, connection information for the open connection channel with the application server hosting the digital media editing application. Moreover, in some implementations, the device connection manager 606 sends instructions from one or more secondary client devices to the application server via the open connection channel to interact with the active session of the digital media editing application and/or implement modifications to digital content open within the active session on the primary client device.

Furthermore, as shown in FIG. 6, the virtual controller integration system 106 includes the control user interface manager 608. In some implementations, the control user interface manager 608 generates and/or provides a control user interface on a secondary client device for interacting with an active session of a digital media editing application running on a primary client device and hosted by an application server. For example, in some implementations, the control user interface manager 608 provides the control user interface on the secondary client device and receives/transmits instructions based on user interactions with the control user interface on the secondary client device. Moreover, in one or more implementations, the control user interface manager 608 provides a plurality of customizable controls on the secondary client device via an interactive display, one or more physical controls, and/or a control surface of the secondary user device.

Each of the components 602-608 of the virtual controller integration system 106 includes software, hardware, or both. For example, the components 602-608 include one or more instructions stored on a computer readable storage medium and executable by processors of one or more computing devices, such as a client device or server device. When executed by the one or more processors, in some implementations, the computer-executable instructions of the virtual controller integration system 106 cause the computing device(s) to perform the methods described herein. Alternatively, in one or more implementations, the components 602-608 include hardware, such as a special purpose processing device to perform a certain function or group of functions. Alternatively, in some implementations, the components 602-608 of the virtual controller integration system 106 include a combination of computer-executable instructions and hardware.

Furthermore, the components 602-608 of the virtual controller integration system 106 are, for example, implemented as one or more operating systems, as one or more stand-alone applications, as one or more modules of an application, as one or more plug-ins, as one or more library functions, as one or more functions callable by other applications, and/or as a cloud-computing model. Thus, in some implementations, the components 602-608 are implemented as a stand-alone application, such as a desktop or mobile application in communication with an application server. Furthermore, in various implementations, the components 602-608 are implemented as one or more web-based applications hosted on a remote server. In some implementations, the components 602-608 are implemented in a suite of mobile device applications or “apps.” To illustrate, in some implementations, the components 602-608 are implemented in an application, including but not limited to ADOBE® PHOTOSHOP, ADOBE® PHOTOSHOP CC, ADOBE® PHOTOSHOP LIGHTROOM, and ADOBE® FIREFLY. The foregoing are either registered trademarks or trademarks of Adobe in the United States and/or other countries.

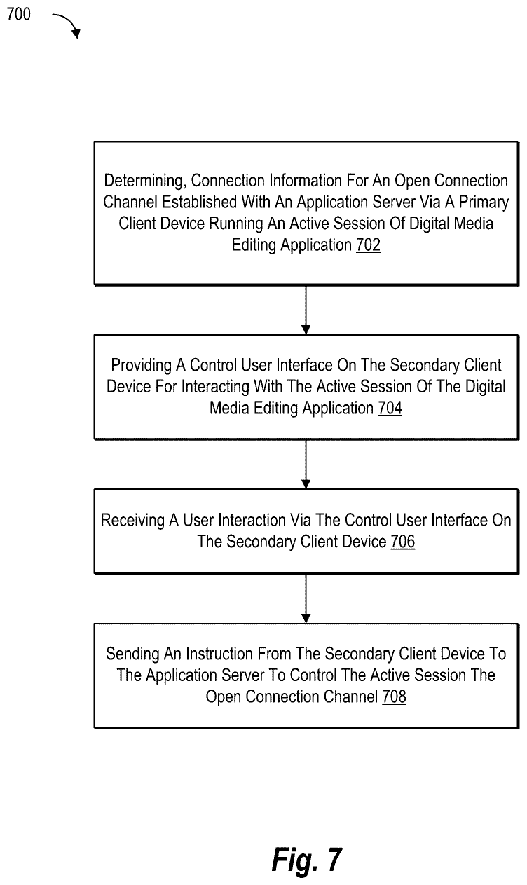

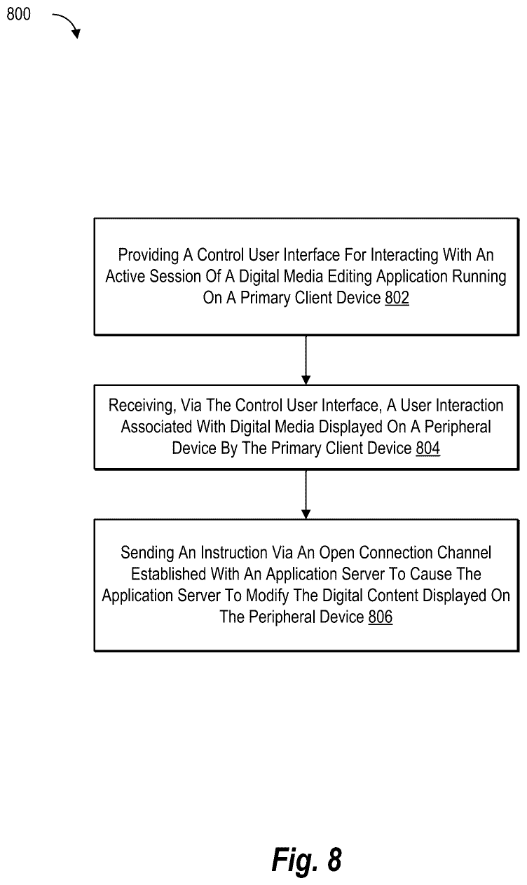

FIGS. 1-6, the corresponding text, and the examples provide a number of different methods, systems, devices, and non-transitory computer readable media of the virtual controller integration system 106. In addition to the foregoing, one or more embodiments are described in terms of flowcharts comprising acts for accomplishing a particular result, as shown in FIGS. 7-8. In some implementations, the processes of the virtual controller integration system 106 are performed with more or fewer acts. Furthermore, in various implementations, the acts are performed in differing orders. Additionally, in some implementations, the acts described herein are repeated or performed in parallel with one another or in parallel with different instances of the same or similar acts.

As mentioned, FIGS. 7 and 8 illustrate flowcharts of respective series of acts 700 and 800 for providing a virtual controller for interacting with an active session of a server-hosted application running on a primary client device. While FIGS. 7-8 illustrate acts according to particular implementations, alternative implementations omit, add to, reorder, and/or modify any of the acts shown in FIGS. 7 and/or 8. In some implementations, the acts of FIGS. 7 and/or 8 are performed as part of a method (e.g., a computer-implemented method). Alternatively, in some implementations, a non-transitory computer readable storage medium comprises instructions that, when executed by one or more processors, cause a computing device to perform the acts of FIGS. 7 and/or 8. In some implementations, a system performs the acts of FIGS. 7 and/or 8.

As shown in FIG. 7, the series of acts 700 includes an act 702 of determining connection information for an open connection channel established with an application server via a primary client device running an active session of a digital media editing application, an act 704 of providing a control user interface on the secondary client device for interacting with the active session of the digital media editing application, an act 706 of receiving a user interaction via the control user interface on the secondary client device, and an act 708 of sending an instruction from the secondary client device to the application server to control the active session via the open connection channel.

In particular, in some embodiments, the act 702 includes determining, by a secondary client device via a local network, connection information for an open connection channel established with an application server hosting a digital media editing application via a primary client device running an active session of the digital media editing application. In some embodiments, the act 704 includes providing a control user interface on the secondary client device for interacting with the active session of the digital media editing application hosted by the application server and running on the primary client device. In some embodiments, the act 706 includes receiving a user interaction via the control user interface on the secondary client device. In some embodiments, the act 708 includes sending an instruction from the secondary client device to the application server to control the active session of the digital media editing application via the open connection channel.

Furthermore, in one or more embodiments, determining the connection information for the open connection channel comprises identifying a service endpoint advertised on the local network by the primary client device. Also, in some embodiments, the service endpoint comprises a discoverable remote service advertised on the local network utilizing zero-configuration networking.

Moreover, in some embodiments, the active session of the digital media editing application running on the primary client device comprises digital content opened in the digital media editing application by the primary client device. Also, in one or more embodiments, the instruction sent from the secondary client device to the application server comprises a modification to the digital content opened in the active session of the digital media editing application on the primary client device. In some embodiments, the open connection channel comprises a simultaneous two-way communication channel over an individual Transmission Control Protocol (TCP) connection to the application server.

In one or more embodiments, providing the control user interface on the secondary client device comprises providing a plurality of operable controls linked to a respective plurality of actionable features of the digital media editing application in use on the primary client device. Also, in some embodiments, providing the control user interface on the secondary client device comprises providing the plurality of operable controls without displaying digital content opened in the active session of the digital media editing application on the primary client device. In some embodiments, the plurality of operable controls comprises one or more of customizable digital controls or configurable tactile controls on the secondary client device.

Additionally, in some embodiments, the series of acts 700 further includes providing an additional control user interface on an additional secondary client device, receiving an additional user interaction via the additional control user interface on the additional secondary client device, and sending an additional instruction from the additional secondary client device to the application server via the open connection channel to control the active session of the digital media editing application on the primary client device.

Moreover, in one or more embodiments, the control user interface comprises a plurality of customizable controls linked to actionable features of the digital media editing application for interacting with digital content accessed by the primary client device within the active session of the digital media editing application. Also, in some embodiments, providing the control user interface comprises portraying the plurality of customizable controls on an interactive display of the secondary client device. Further, in some embodiments, the secondary client device comprises a digital controller or control surface configured to communicate via the open connection channel to the application server. In addition, in some embodiments, providing the control user interface comprises associating one or more physical controls of the digital controller or control surface with one or more of the actionable features of the digital media editing application.

As shown in FIG. 8, the series of acts 800 includes an act 802 of providing a control user interface for interacting with an active session of a digital media editing application running on a primary client device, an act 804 of receiving, via the control user interface, a user interaction associated with digital media displayed on a peripheral device by the primary client device, and an act 806 of sending an instruction via an open connection channel established with an application server to cause the application server to modify the digital content displayed on the peripheral device.

In particular, in some embodiments, the act 802 includes providing a control user interface for interacting with an active session of a digital media editing application running on a primary client device as the primary client device displays digital content on a peripheral device. In some embodiments, the act 804 includes receiving, via the control user interface, a user interaction associated with the digital content displayed on the peripheral device. In some embodiments, the act 806 includes sending an instruction via an open connection channel established with an application server hosting the digital media editing application to cause the application server to modify the digital content displayed on the peripheral device according to the user interaction.

Furthermore, in one or more embodiments, the digital content comprises a digital image, a digital video, an audio composition file, an interactive media file, a three-dimensional model, or a digital document. In some embodiments, providing the control user interface comprises providing a plurality of operable controls linked to a respective plurality of actionable features of the digital media editing application for interacting with the digital content within the active session on the primary client device.

Moreover, in some embodiments, the open connection channel comprises a continuous full-duplex communication channel established with the application server via the primary client device. In one or more embodiments, the series of acts 800 further includes determining, via a discoverable zero-configuration networking service on a local network, connection information for the open connection channel established with the application server via the primary client device.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer readable media for carrying or storing computer-executable instructions and/or data structures. In particular, one or more of the processes described herein may be implemented at least in part as instructions embodied in a non-transitory computer readable medium and executable by one or more computing devices (e.g., any of the media content access devices described herein). In general, a processor (e.g., a microprocessor) receives instructions, from a non-transitory computer readable medium, (e.g., a memory, etc.), and executes those instructions, thereby performing one or more processes, including one or more of the processes described herein.

Computer readable media can be any available media that can be accessed by a general purpose or special purpose computer system. Computer readable media that store computer-executable instructions thereon are non-transitory computer readable storage media (devices). Computer readable media that carry computer-executable instructions thereon are transmission media. Thus, by way of example, and not limitation, embodiments of the disclosure can comprise at least two distinctly different kinds of computer readable media: non-transitory computer readable storage media (devices) and transmission media. Non-transitory computer readable storage media (devices) includes optical and/or non-optical memory, disks, or caches that store computer data interpretable by one or more processors to execute particular functions as described herein. A “network” is defined as one or more data links that enable the transport of electronic data between computer systems and/or modules and/or other electronic devices. Information is transferred or provided over a network (either hardwired, wireless, or a combination of hardwired or wireless) to a computer to carry program code in the form of computer-executable instructions or data structures and which can be accessed by a general purpose or special purpose computer.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code.

Embodiments of the present disclosure can also be implemented in cloud computing environments. In this description, “cloud computing” is defined as a model for enabling on-demand network access to a shared pool of configurable computing resources. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth.

FIG. 9 illustrates, in block diagram form, an example computing device 900 (e.g., the computing device 900, the primary client device 108, the secondary client device(s) 114, and/or the server device(s) 102) that may be configured to perform one or more of the processes described above. As shown by FIG. 9, the computing device 900 can comprise a processor(s) 902, memory 904, a storage device 906, an I/O interface 908, and a communication interface 910.

In particular embodiments, processor(s) 902 includes hardware for executing instructions, such as those making up a computer program. As an example, and not by way of limitation, to execute instructions, processor(s) 902 may retrieve (or fetch) the instructions from an internal register, an internal cache, memory 904, or a storage device 906 and decode and execute them. The computing device 900 includes memory 904, which is coupled to the processor(s) 902. The memory 904 may be used for storing data, metadata, and programs for execution by the processor(s). The memory 904 may include one or more of volatile and non-volatile memories. The memory 904 may be internal or distributed memory. The computing device 900 includes a storage device 906 includes storage for storing data or instructions. As an example, and not by way of limitation, storage device 906 can comprise a non-transitory storage medium described above. The computing device 900 also includes one or more input or output (“I/O”) devices/interfaces 908, which are provided to allow a user to provide input to (such as user strokes), receive output from, and otherwise transfer data to and from the computing device 900. These I/O devices/interfaces 908 may include a mouse, keypad or a keyboard, a touch screen, camera, optical scanner, network interface, modem, other known I/O devices or a combination of such I/O devices/interfaces 908.

The computing device 900 can further include a communication interface 910. The communication interface 910 can include hardware, software, or both. The communication interface 910 can provide one or more interfaces for communication (such as, for example, packet-based communication) between the computing device and one or more other computing devices (e.g., computing device 900) or one or more networks. The computing device 900 can further include a bus 912. The bus 912 can comprise hardware, software, or both that couples components of computing device 900 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
determining, by a secondary client device via a local network, connection information for an open connection channel established with an application server hosting a digital media editing application via a primary client device running an active session of the digital media editing application;
providing a control user interface on the secondary client device for interacting with the active session of the digital media editing application hosted by the application server and running on the primary client device;
receiving a user interaction via the control user interface on the secondary client device; and
sending an instruction from the secondary client device to the application server to control the active session of the digital media editing application via the open connection channel.

2. The computer-implemented method of claim 1, wherein determining the connection information for the open connection channel comprises identifying a service endpoint advertised on the local network by the primary client device.

3. The computer-implemented method of claim 2, wherein the service endpoint comprises a discoverable remote service advertised on the local network utilizing zero-configuration networking.

4. The computer-implemented method of claim 1, wherein the active session of the digital media editing application running on the primary client device comprises digital content opened in the digital media editing application by the primary client device.

5. The computer-implemented method of claim 4, wherein the instruction sent from the secondary client device to the application server comprises a modification to the digital content opened in the active session of the digital media editing application on the primary client device.

6. The computer-implemented method of claim 1, wherein the open connection channel comprises a simultaneous two-way communication channel over an individual Transmission Control Protocol (TCP) connection to the application server.

7. The computer-implemented method of claim 1, wherein providing the control user interface on the secondary client device comprises providing a plurality of operable controls linked to a respective plurality of actionable features of the digital media editing application in use on the primary client device.

8. The computer-implemented method of claim 7, wherein providing the control user interface on the secondary client device comprises providing the plurality of operable controls without displaying digital content opened in the active session of the digital media editing application on the primary client device.

9. The computer-implemented method of claim 7, wherein the plurality of operable controls comprises one or more of customizable digital controls or configurable tactile controls on the secondary client device.

10. The computer-implemented method of claim 1, further comprising:
providing an additional control user interface on an additional secondary client device;
receiving an additional user interaction via the additional control user interface on the additional secondary client device; and
sending an additional instruction from the additional secondary client device to the application server via the open connection channel to control the active session of the digital media editing application on the primary client device.

11. A system comprising:
one or more memory devices; and
one or more processors coupled to the one or more memory devices that cause the system to perform operations comprising:
providing a control user interface for interacting with an active session of a digital media editing application running on a primary client device as the primary client device displays digital content on a peripheral device;
receiving, via the control user interface, a user interaction associated with the digital content displayed on the peripheral device; and
sending an instruction via an open connection channel established with an application server hosting the digital media editing application to cause the application server to modify the digital content displayed on the peripheral device according to the user interaction.

12. The system of claim 11, wherein the digital content comprises a digital image, a digital video, an audio composition file, an interactive media file, a three-dimensional model, or a digital document.

13. The system of claim 11, wherein providing the control user interface comprises providing a plurality of operable controls linked to a respective plurality of actionable features of the digital media editing application for interacting with the digital content within the active session on the primary client device.

14. The system of claim 11, wherein the open connection channel comprises a continuous full-duplex communication channel established with the application server via the primary client device.

15. The system of claim 14, the operations further comprising determining, via a discoverable zero-configuration networking service on a local network, connection information for the open connection channel established with the application server via the primary client device.

16. A non-transitory computer readable medium storing instructions thereon that, when executed by at least one processor, cause the at least one processor to perform operations comprising:
determining, by a secondary client device via a local network, connection information for an open connection channel established with an application server hosting a digital media editing application via a primary client device running an active session of the digital media editing application;
providing a control user interface on the secondary client device for interacting with the active session of the digital media editing application hosted by the application server and running on the primary client device;
receiving a user interaction via the control user interface on the secondary client device; and
sending an instruction from the secondary client device to the application server to control the active session of the digital media editing application via the open connection channel.

17. The non-transitory computer readable medium of claim 16, wherein the control user interface comprises a plurality of customizable controls linked to actionable features of the digital media editing application for interacting with digital content accessed by the primary client device within the active session of the digital media editing application.

18. The non-transitory computer readable medium of claim 17, wherein providing the control user interface comprises portraying the plurality of customizable controls on an interactive display of the secondary client device.

19. The non-transitory computer readable medium of claim 17, wherein the secondary client device comprises a digital controller or control surface configured to communicate via the open connection channel to the application server.

20. The non-transitory computer readable medium of claim 19, wherein providing the control user interface comprises associating one or more physical controls of the digital controller or control surface with one or more of the actionable features of the digital media editing application.
